(19) United States
(12) Patent Application Publication
(10) Pub. No.: US 2020/0240097 A1
(43) Pub. Date: Jul. 30, 2020

(54) SYSTEM AND METHOD OF REPAIRING SEAWALLS AND CHANNEL WALLS

(71) Applicant: Infrastructure Technologies, LLC, Lafayette, CA (US)

(72) Inventor: JOSEPH ROSEMONT, Brainerd, MN (US)

(21) Appl. No.: 16/261,867

(22) Filed: Jan. 30, 2019

(51) Int. Cl. E02B 3/06; B32B 27/20; E02D 37/00; E02D 29/02

(52) U.S. Cl. CPC E02B 3/066; B32B 27/20; E02D 2300/0054; E02D 29/02; B32B 2419/00; E02D 37/00

(57) ABSTRACT

A repair system for existing aquatic walls including seawalls, channel walls other water barriers includes a laminate sheet constructed of a fiber reinforced polymer that is adhered along its perimeter and bolted to the surface of an aquatic wall. An annular gap is formed between the adhered/bolted laminate sheet and the aquatic wall, and that gap is injected with an exothermic bonder that connects the laminate sheet to the aquatic wall.

### BACKGROUND OF THE INVENTION

The present invention relates to aquatic walls such as seawalls, channel walls, and other walls designed to hold back water, and more specifically, to a system and method of repairing walls, employing pre-formed laminate sheets that are anchored to an existing wall in a manner that forms an annular gap between a sheet and the wall, then injecting that gap with bonder.

Seawall structures, for example, are built where water meets land, to prevent or slow the erosion of the shoreline. More specifically, they provide a solid barrier to buffer the land from wave action, storm surges, flooding, and general erosion. Channel walls are similar as they are designed to provide a solid barrier to buffer land from water run-off. Unfortunately, both seawalls and channel walls deteriorate over time due to the forces they absorb, normal material degradation, and other environmental factors. Standard concrete seawalls and channel walls typically require repair within approximately 10 years of being built.

It is known to repair seawalls and channel walls in situ using concrete and a variety of patches constructed of different materials. For example, fiber reinforced polymer laminate sheets can be prepared at a repair site and attached to a wall, but this often leads to defective laminate sheets due to the less-thanideal manufacturing conditions. Also, laminate sheets are difficult to permanently attach to walls using known attachment methods.

As can be seen, there is a need for a system and method of repairing walls whose components can be prepared in advance, and which are permanently attached, durable, and effectively repair and reinforce walls. It is desirable that this system and method is stronger, and lasts substantially longer, than known systems and methods. It is also desirable that this system and method requires less labor, and less turnaround time, as compared to known systems and methods of repairing walls.

### SUMMARY OF THE INVENTION

The repair system of the present invention includes a laminate sheet that is adhered along its perimeter and bolted to the surface of an existing wall. Because the laminate sheet is adhered along its perimeter, an annular gap is formed between the adhered/bolted laminate sheet and the wall, and bordered by the adhesive. That gap is subsequently injected with a bonder. This bonder further connects the laminate sheet to the wall, providing mechanical strength to the reinforced wall.

### BRIEF DESCRIPTION OF THE DRAWINGS

FIG. 1 is an exploded perspective view of a repair system;

FIG. 2 is a top view of a wall in various stages of repair;

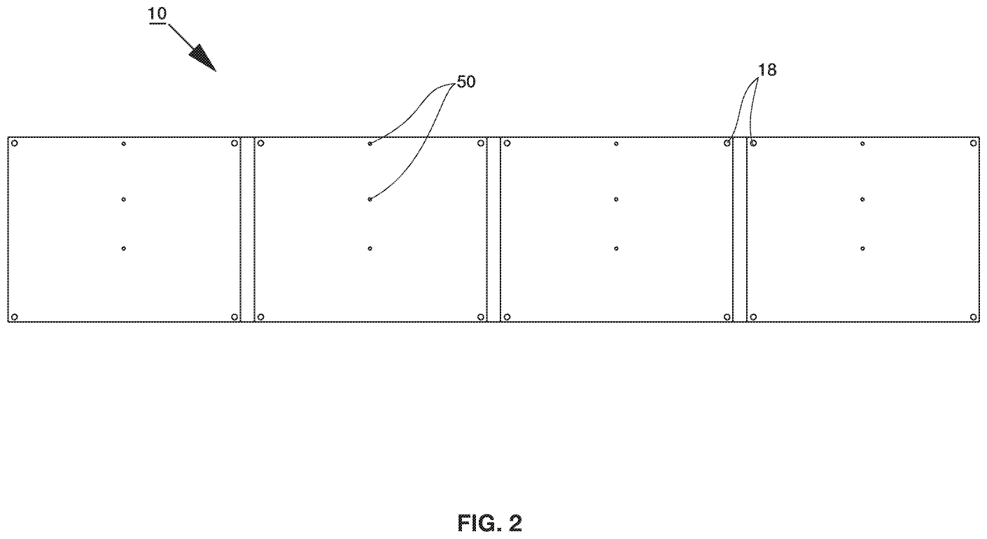

FIG. 3 is an exploded side view of a repair system;

FIG. 4 is an exploded bottom view of a repair system; and

FIG. 5 is an exploded perspective view of a wall.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structure numbers shall apply to the following structures among the various FIGS.:
10—Repair system;
15—Wall;
16—Repair surface;
17—Column;
18—Incision;
20—Laminate sheet;
21—Pilot hole;
22—FRP substrate;
24—Matrix;
26—Coating;
30—Anchor;
34—Anchor receptacle;
40—Putty;
50—Injection port;
52—Annular gap; and
60—Injected bonder.

Broadly, the repair system of the present invention includes a laminate sheet that is adhered along its perimeter and bolted to the surface of a wall. As used herein, “wall”, “barrier”, “aquatic walls” and the like refer to seawalls, channel walls, and other structures that form a border or barrier between land and water. An annular gap is formed between the adhered/bolted laminate sheet and the wall, and that gap is injected with a bonder, further connecting the laminate sheet to the wall, and providing mechanical strength there to.

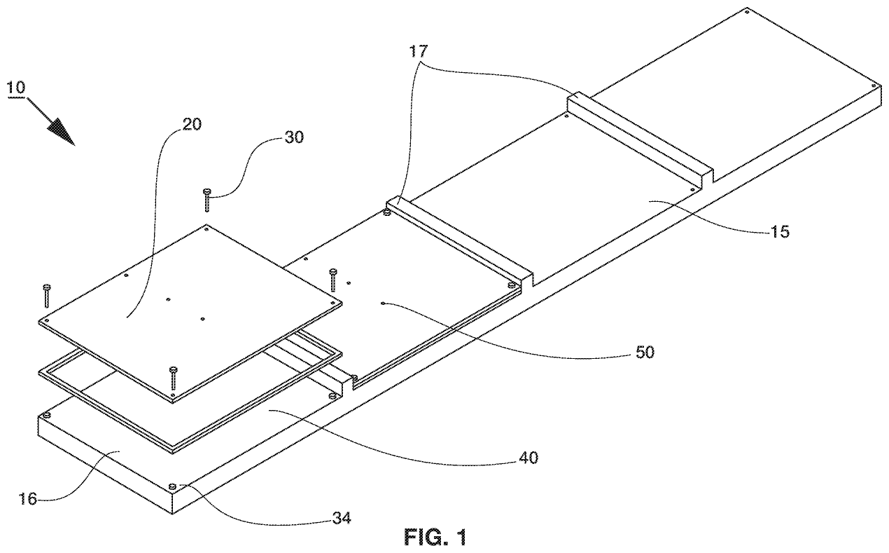

Referring to FIG. 1, repair system 10 generally includes laminate sheet 20 connected to repair surface 16 of wall 15 by perimeter of putty 40, and a plurality of anchors 30.

As a preliminary step, wall 15 is preferably prepared by removing contaminates such as dirt, mollusks, plant matter, sand, degraded concrete, etc. in order to provide relatively debris-free repair surface 16. In a preferred embodiment, a plurality of incisions 18 are introduced, for example drilled, into repair surface 16, and those incisions are fitted with an appropriate anchor receptacle 34, such as a washer/spacer. It should be understood that the system and method of the present invention can be used with a variety of configurations of walls, including those having columns 17.

Laminate sheet 20 is preferably constructed of a fiber reinforced polymer (FRP) substrate 22 such as non-woven or woven fabric which is integrated with fiberglass, carbon fiber, plastic, metal, meta-aramids, para-aramids, and/or composite materials. The preferred FRP substrate is SWSCLS Composite Laminate System from Specialty Composite Systems of Fontana, Calif. FRP substrate 22 is preferably saturated with matrix 24 such as the epoxy resin SWS737 Part A from Specialty Composite Systems in Fontana, Calif., and allowed to harden or cure. The FRP substrate with cured matrix preferably includes coating 26 such as epoxy hardener SWS737 Part B coating Specialty Composite Systems in Fontana, Calif. The specific components of laminate sheet 20 (RFP substrate 22, matrix 24 and coating 26) are selected to collectively provide the desired mechanical properties such as tensile strength, compressive strength, and modulus of elasticity.

Laminate sheet 20 is preferably adhered to repair surface 16 using putty 40 which is deposited onto perimeter of laminate sheet 20, or onto repair surface 16 where perimeter of laminate sheet will be positioned upon application. Putty 40 is preferably a thixotropic water insensitive epoxy resin such as SWS3LV Water Insensitive Low Viscosity Resin manufactured by Specialty Composite Systems in Fontana, Calif., and is preferably of adequate viscosity that it can be molded by hand into the desired shape, or smeared like spackle with a spackle knife, so as to be applied to vertical structures without falling off.

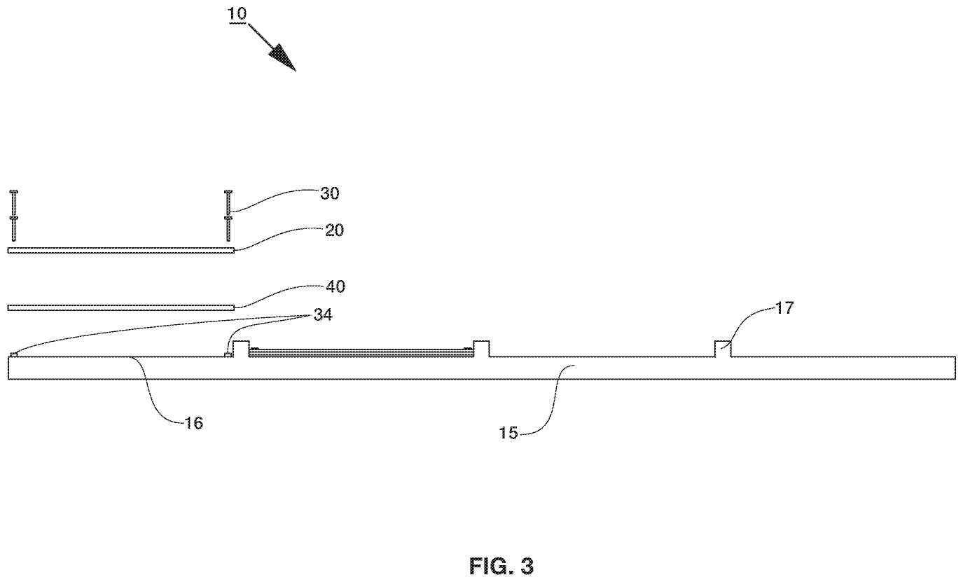

After application of putty 40 to repair surface 16 and/or laminate sheet 20, laminate sheet is adhered to repair surface. As shown in FIG. 3, anchor receptacles 34 serve as spacers, thereby maintaining laminate sheet 20 a specific distance from repair surface 16. This ensures that the volume and location of putty is sufficient to create a seal between the outside perimeter of the laminate sheet and the repair surface.

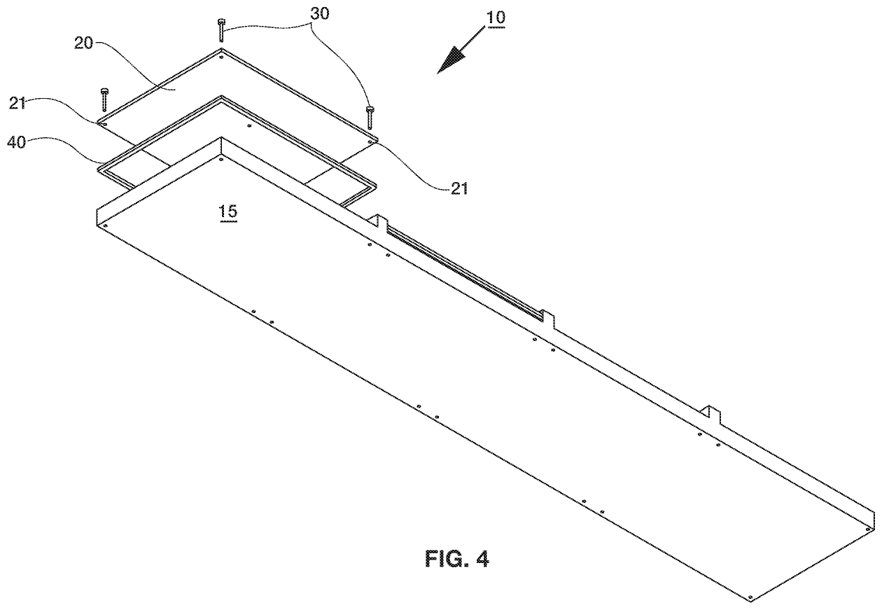

As best shown in FIG. 4, anchors 30, preferably RED HEAD anchors, are inserted into pilot holes 21 defined by laminate sheet 20. Anchors pass through putty 40 and are secured in anchor receptacles 34. Annular gap 52 (not shown) is formed between laminate sheet 20 and repair surface 16, with the perimeter of the gap formed by putty 40.

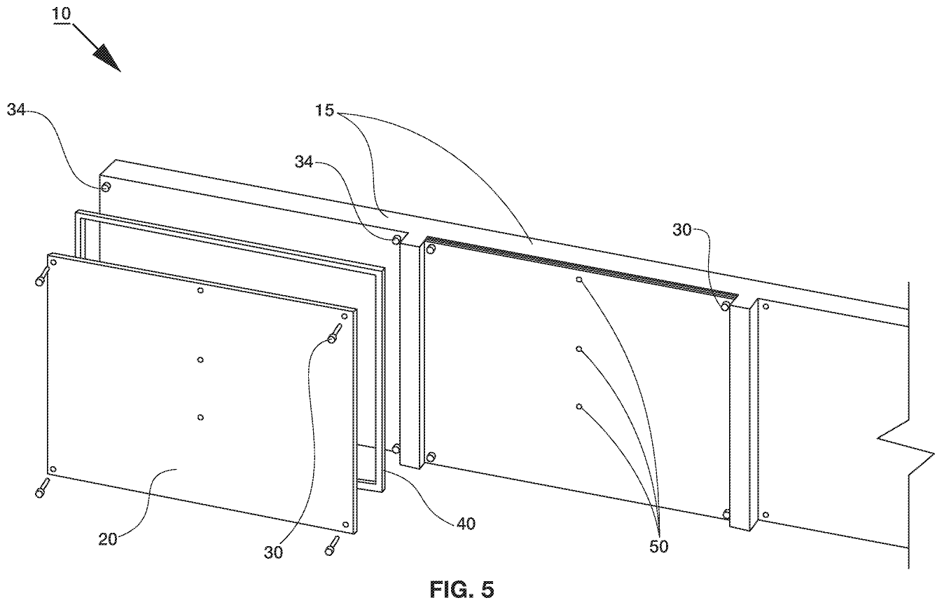

Upon drying/curing of putty 40, a plurality of injection ports 50 are introduced, for example drilled, into laminate sheet 20. This is best shown in FIGS. 1 and 5. In an alternative embodiment, laminate sheet 20 is predrilled with injection ports 50 prior to adherence to repair surface 16.

As a final step, annular gap 52 is filled, or substantially filled, with injected bonder 60, which is introduced through injection ports 50. This bonder preferably causes an exothermic reaction, which cures to form a tenacious bond between laminate sheet 20 and repair surface 16. In a preferred embodiment, injected bonder 60 is SWS737T underwater tack coat, from Specialty Composite Systems of Fontana, Calif.

It should be understood that the foregoing relates to exemplary embodiments of the invention and that modifications may be made without departing from the spirit and scope of the invention as set forth in the following claims. By way of example, this invention could be used on bulk heads, retaining walls, and other structures. Terms such as “substantially” and the like shall mean within reasonable bounds when considering limitations such as machines, materials, manufacturing methods, and people. By way of example, a “substantially smooth” surface means there are no intentional bumps or irregularities. All ranges set forth herein include the endpoints as well as all increments there between, even if not specifically stated. By way of example 1 to 2 inches includes 1 inch, 1.000001 inches and so forth. Finally, unless otherwise stated or contrary to common sense, “approximate” and the like shall mean+/−10%.

1. A repair system for aquatic walls including:
A. A substantially planar laminate sheet for connecting to a repair surface, said laminate sheet including a Fiber Reinforced Polymer (FRP) substrate and a perimeter;
B. Putty along said perimeter, said putty forming an enclosure;
C. Bonder substantially within said enclosure;
D. A plurality of anchor receptacles engaged with said repair surface; and
E. A plurality of anchors engaged with said anchor receptacles, wherein said anchor receptacles maintain said laminate sheet a specific distance from said repair surface.

2. The repair system of claim 1 wherein said bonder is bound on one side by said laminate sheet.

3. The repair system of claim 1 wherein said laminate sheet is substantially parallel to said repair surface.

4. (canceled)

5. The repair system of claim 1 wherein said anchor receptacles are spacer washers.

6. An aquatic wall including:
A. A substantially smooth repair surface;
B. A plurality of anchor receptacles engaged with said repair surface;
C. A substantially planar laminate sheet including a Fiber Reinforced Polymer (FRP), said laminate sheet substantially parallel to said substantially smooth repair surface, said laminate sheet including a perimeter;
D. Putty along said perimeter, said putty forming an enclosure;
E. Cured bonder substantially within said enclosure, wherein said cured bonder is joined to said substantially smooth repair surface; and
F. A plurality of anchors engaged with said anchor receptacles, wherein said anchor receptacles maintain said laminate sheet a specific distance from said repair surface.

7. The aquatic wall of claim 6 wherein said substantially smooth repair surface is concrete.

8. The aquatic wall of claim 6 wherein said laminate sheet defines at least one injection port.

9. The aquatic wall of claim 6 wherein said putty is a thixotropic water insensitive epoxy resin.

10. (canceled)

11. (canceled)

12. The aquatic wall of claim 6 wherein said anchor receptacles are spacer washers.

13. A method of repairing existing aquatic walls including the non-sequential steps of:
A. Removing debris from an aquatic wall to establish a repair surface;
B. Engaging a plurality of anchor receptacles with said repair surface;
C. Depositing a layer of putty around the perimeter of a substantially planar laminate sheet including a Fiber Reinforced Polymer (FRP);
D. Attaching said laminate sheet to said repair surface by engaging a plurality of anchors with said plurality of anchor receptacles thereby forming an annular gap bordered on four sides by said putty, on one side by said laminate sheet, and one side by said repair surface, wherein said anchor receptacles maintain said laminate sheet a specific distance from said repair surface; and
E. Injecting a bonder into said annular gap.

14. The method of repairing existing aquatic walls of claim 13 wherein said step of depositing a layer of putty around the perimeter of a laminate sheet includes the step of depositing a layer of putty around the perimeter of a laminate sheet defining an injection port.

15. The method of repairing existing aquatic walls of claim 14 wherein said step of injecting a bonder into said annular gap includes the step of injecting a bonder through said injection port.

16. The method of repairing existing aquatic walls of claim 13 wherein said step of injecting bonder into said annular gap includes the step of injecting an exothermic bonder that connects said laminate sheet to said repair surface.

17. The method of repairing existing aquatic walls of claim 13 further including the step of introducing incisions into said repair surface.

18. The method of repairing existing aquatic walls of claim 17 further including the step of fitting said incisions with said anchor receptacles.
